(19) United States
(12) Patent Application Publication
(10) Pub. No.: US 2019/0226584 A1
(43) Pub. Date: Jul. 25, 2019

(54) LIP SEAL WITH AIR-SIDE SPRING

(71) Applicant: American Axle & Manufacturing, Inc., Detroit, MI (US)

(72) Inventors: Michael Cabaj, Canton, MI (US); Alan Jay Bowers, Huntington, IN (US)

(21) Appl. No.: 15/874,988

(22) Filed: Jan. 19, 2018

(51) Int. Cl. F16J 15/3232

(52) U.S. Cl. CPC F16J 15/3232

(57) ABSTRACT

A seal assembly that includes a case member, which is configured to be received in a seal bore in a housing, a first dynamic seal, which is configured to sealingly engage a shaft that is rotatably supported in a housing, and a second dynamic seal that is configured to sealingly engage a slinger that is coupled to the shaft for rotation therewith. The second dynamic seal has an annular seal lip and a spring member that is located on an “air side” of the annular lip seal. The spring member is configured to bias the annular lip seal in a pivoting manner about the axis and into contact with a surface on the slinger.

### FIELD

The present disclosure relates to a lip seal with an air-side spring.

### BACKGROUND

This section provides background information related to the present disclosure which is not necessarily prior art.

In seal assemblies for automotive vehicles in which a lip seal is employed to form a dynamic seal between a housing and a shaft that is rotatably supported in the housing, it is fairly common in the art to employ a slinger on the shaft to protect the lip seal from dirt and debris (e.g., rocks, stones). It is possible for dirt and debris (mud in particular) to build up between the slinger and the lip seal. The accumulation of dirt and debris in this area can be difficult to detect, let alone remove. In situations where a relatively large amount of dirt and debris collects, the collected dirt and debris can contact an axial end face of the lip seal, which could shorten the life of the lip seal under some circumstances.

### SUMMARY

This section provides a general summary of the disclosure, and is not a comprehensive disclosure of its full scope or all of its features.

In one form, the present teachings provide a seal assembly that includes a case structure, a first dynamic seal and a second dynamic seal. The case structure defines an annular case member that is disposed longitudinally along an axis. The first dynamic seal is coupled to the case structure and has a first annular seal lip and a first spring member. The first annular seal lip has a first sealing surface that is disposed about the axis concentric with the annular case member such that the first sealing surface is spaced from the axis by a first distance (r1). The first spring member engages the first annular seal lip and biases the first sealing surface in a radially inward direction toward the axis. The second dynamic seal is coupled to the case structure and is spaced apart along the axis from the first dynamic seal. The second dynamic seal has a second annular seal lip and a second spring member. The second annular seal lip has a second sealing surface that is disposed concentrically about the axis such that the second sealing surface is spaced from the axis by a second distance (r2) that is larger than the first distance (r1). The second spring member engages the second annular seal lip and biases the second sealing surface toward the axis.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a portion of a longitudinal section view of an exemplary seal assembly having a seal constructed in accordance with the teachings of the present disclosure; and

FIG. 2 is an enlarged portion of the seal assembly of FIG. 1 illustrating the seal in more detail.

Corresponding reference numerals indicate corresponding parts throughout the several views of the drawings.

### DETAILED DESCRIPTION

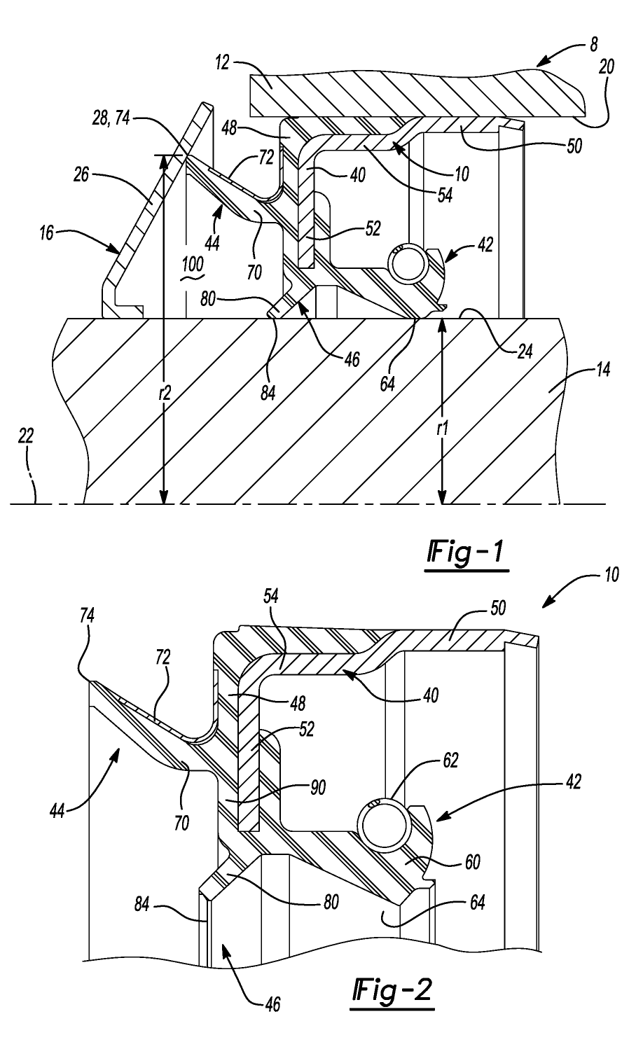

With reference to FIGS. 1 and 2 of the drawings, an exemplary seal assembly 8 is shown to include a seal 10 that is constructed in accordance with the teachings of the present disclosure. The seal assembly 8 can further include a housing 12, a shaft 14 and a slinger 16. The housing 12 can define a seal bore 20 that can be disposed along a longitudinal axis 22 of the seal 10. The shaft 14 can be received in the housing 12 for rotation about the longitudinal axis 22 and can include a shaft surface 24 that can be generally concentric with the seal bore 20. The slinger 16 can be formed of a sheet steel or plastic material and is coupled to the shaft 14 for rotation therewith. The slinger 16 has a slinger member 26 that extends radially outwardly from the shaft 14 with a frusto-conical and/or spherical shape. The slinger member 26 is configured to shroud or cover an axial end of the seal bore 20 to thereby protect the seal from dirt and debris that may otherwise contact the seal 10. The slinger member 26 defines a slinger surface 28 that faces toward the axial end of the seal bore 20.

The seal 10 can include a case structure 40, a first dynamic seal 42, a second dynamic seal 44 and a third dynamic seal 46. The case structure 40 can be formed of an appropriate material, such as sheet steel, and can define an annular case member 50, a radial case member 52 and a connecting portion 54 that can fixedly couple the annular case member 50 to the radial case member 52. The annular case member 50 can be disposed longitudinally along and concentrically about the axis 22 and can be sized to sealingly engage the seal bore 20 that is formed in the housing 12. It will be appreciated that various coatings, paint, sealants and/or adhesive materials (not specifically shown) can be coupled to the annular case member 50 and may form a seal or interface between the exterior surface of the annular case member 50 and the seal bore 20. The radial case member 52 can have an annular shape that can be similar to that of a washer. The connecting portion 54 can couple the radial case member 52 to the annular case member 50.

The first dynamic seal 42 can be coupled to the case structure 40 and can include a first annular seal lip 60 and a first spring member 62. The first annular seal lip 60 can be formed of any type of sealing material (e.g., PTFE), but in the example provided, is formed from an elastomeric material from which an optional seal body 48 is formed. The first annular seal lip 60 can have a first sealing surface 64 that is disposed about the axis 22 concentric with the annular case member 50 such that the first sealing surface 64 is spaced from the axis by a first distance r1. The first sealing surface 64 is configured to sealingly engage the shaft surface 24 as the shaft 14 rotates relative to the housing 12. The first spring member 62 can engage the first annular seal lip 60 and can bias the first sealing surface 64 in a radially inward direction toward the axis 22. The first spring member 62 can be a conventional garter spring that can be formed of helically wound wire. It will be appreciated, however, that the first spring member 62 could be formed differently from that which is shown here.

The second dynamic seal 44 can be coupled to the case structure 40 at a location that is spaced apart from the first dynamic seal 42 along the axis 22. The second dynamic seal 44 can include a second annular seal lip 70 and a second spring member 72. The second annular seal lip 70 can be formed of any type of sealing material (e.g., PTFE), but in the example provided, is formed from an elastomeric material from which the seal body 48 is formed.

The second annular seal lip 70 can have a second sealing surface 74 that is disposed concentrically about the axis 22 such that the second sealing surface 74 is spaced from the axis 22 by a second distance r2 that is larger than the first distance r1. The second annular seal lip 70 can be sized and shaped to permit the second sealing surface 74 to sealingly engage the slinger surface 28 on the slinger member 26. For example, the second annular seal lip 70 can be frusto-conically shaped and can extend from the seal body 48 in a manner that diverges from the axis 22 with increasing distance away from the first annular seal lip 60. The second sealing surface 74 can be configured to sealingly engage the slinger surface 28 and can be shaped in a manner that mates or conforms to the slinger surface 28. In the example provided, the slinger surface 28 is frusto-conically shaped and the second sealing surface 74 has a frusto-conical shape that is centered about the axis 22. The second spring member 72 can engage the second annular seal lip 70 and can bias the second sealing surface 74 toward the axis 22.

The third dynamic seal 46 can be coupled to the case structure 40 and can include a third annular seal lip 80. The third annular seal lip 80 can have a third sealing surface 84 that is disposed about the axis 22 concentric with the first sealing surface 64. The third sealing surface 84 can be disposed along the axis 22 between the first sealing surface 64 and the second sealing surface 74.

In the example provided, the first annular seal lip 60, the second annular seal lip 70 and the third annular seal lip 80 are unitarily and integrally formed with the seal body 48 from a suitable elastomeric material that can be overmolded (i.e., cohesively bonded to) or otherwise fixedly coupled to the case structure 40. The seal body 48 can extend over the connecting portion 54 of the case structure 40 and can optionally sealingly engage the internal surface of the seal bore 20. The seal body 48 can include a radially extending portion 90 that is disposed on the radial case member 52 so that the radially extending portion 90 of the seal body 48 extends radially between the first annular seal lip 60 and the annular case member 50. The second annular seal lip 70 can extend from the radially extending portion 90 on a side of the radial case member 52 that is opposite the first annular seal lip 60. The second spring member 72 can be configured to pivot the second annular seal lip 70 about the zone or area where the second annular seal lip 70 connects to the radially extending portion 90 of the seal body 48. It will be appreciated that the second spring member 72 is located on the “air side” (i.e., non-sealed side) of the second annular seal lip 70. Configuration in this manner permits the second spring member 72 to help maintain sealing contact between the second sealing surface 74 and the slinger surface 28 so that dirt and debris does not infiltrate into a void space 100 between the slinger 16 and the third annular seal lip 80.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A seal assembly comprising:
a case structure defining an annular case member that is disposed longitudinally along an axis;
a first dynamic seal coupled to the case structure and extending therefrom in a first axial direction along the axis, the first dynamic seal having a first annular seal lip and a first spring member, the first annular seal lip having a first sealing surface that is disposed about the axis concentric with the annular case member such that the first sealing surface is spaced from the axis by a first distance (r1), the first spring member engaging the first annular seal lip and biasing the first sealing surface in a radially inward direction toward the axis; and
a second dynamic seal coupled to the case structure and extending therefrom in a second axial direction along the axis, the second axial direction being opposite the first axial direction, the second dynamic seal having a second annular seal lip and a second spring member, the second annular seal lip being frustoconical in shape and diverging from the axis with increasing from the case structure in the second axial direction, the second annular seal lip having a second sealing surface that is disposed concentrically about the axis such that the second sealing surface is spaced from the axis by a second distance (r2) that is larger than the first distance (r1), the second spring member engaging the second annular seal lip and biasing the second sealing surface toward the axis, the second spring member being a type of annular leaf spring haying a frustoconical portion that is matingly engaged with the second annular seal lip.

2. The seal assembly of claim 1, wherein the first and second annular seal lips are unitarily and integrally formed with a seal body.

3. The seal assembly of claim 2, wherein the seal body comprises a radially extending portion that is disposed radially between the first annular seal lip and the annular case member, and wherein the second annular seal lip extends from the radially extending portion.

4. (canceled)

5. (canceled)

6. The seal assembly of claim 2, further comprising a third annular seal lip coupled to the seal body, the third annular seal lip having a third sealing surface that is disposed about the axis concentric with the first sealing surface, the third sealing surface being disposed along the axis between the first sealing surface and the second sealing surface.

7. (canceled)

8. The seal assembly of claim 1, wherein the first spring member comprises a garter spring.

9. The seal assembly of claim 1, further comprising:
a housing defining a seal bore into which the annular case member is received;
a shaft disposed in the housing for rotation about the axis, the shaft having a shaft surface concentrically disposed about the axis and sealingly engaging the first sealing surface; and
a slinger coupled to the shaft for rotation therewith, the slinger having a slinger having a slinger member that is frusto-conically and/or spherically shaped, the slinger member extending radially outwardly from the shaft and covering an axial end of the seal bore in the housing, wherein the slinger member defines a slinger surface that is sealingly engaged to the second sealing surface.
